(19) United States
(12) Patent Application Publication
(10) Pub. No.: US 2014/0169488 A1
(43) Pub. Date: Jun. 19, 2014

(54) NARROW-BAND PREAMBLE FOR ORTHOGONAL FREQUENCY-DIVISION MULTIPLEXING SYSTEM

(71) Applicant: QUALCOMM Incorporated, San Diego, CA (US)

(72) Inventors: Nicola Varanese, Nuremberg (DE); Muhammad Awais Amin, Nuremberg (DE); Christoph A. Joetten, Wadern (DE); Juan Montojo, Nuremberg (DE)

(73) Assignee: QUALCOMM Incorporated, San Diego, CA (US)

(21) Appl. No.: 13/966,128

(22) Filed: Aug. 13, 2013

Related U.S. Application Data
(60) Provisional application No. 61/738,367, filed on Dec. 17, 2012.

(51) Int. Cl. H04L 27/26

(52) U.S. Cl. CPC H04L 27/2602
USPC 375/260; 375/295; 375/298; 375/340; 375/343

(57) ABSTRACT

A method of signal generation includes selecting a subset of contiguous OFDM symbols from a set of contiguous OFDM symbols, selecting a subset of contiguous subcarriers from a set of subcarriers, and generating a preamble that occupies the subset of contiguous subcarriers in the subset of contiguous OFDM symbols. The preamble includes portions in respective OFDM symbols of the subset of contiguous OFDM symbols. In the time domain each preamble portion corresponds to a repeating sequence of samples when subcarriers outside of the subset of contiguous subcarriers are filtered out. Generating the preamble may include flipping the sign of one or more occurrences of the repeating sequence for a final preamble portion and may include placing modulation symbols on regularly spaced subcarriers in the subset of contiguous subcarriers and phase-shifting the modulation symbols for a respective preamble portion with respect to a previous preamble portion.

### RELATED APPLICATION

This application claims priority to U.S. Provisional Patent Application No. 61/738,367, titled “Narrow Band Preamble for Orthogonal Frequency Division Multiplexing System,” filed Dec. 17, 2012, which is hereby incorporated by reference in its entirety.

### TECHNICAL FIELD

The present embodiments relate generally to communications systems, and specifically to preamble signal design for physical-layer frames in an orthogonal frequency-division multiplexing (OFDM) communication system.

### BACKGROUND OF RELATED ART

In an orthogonal frequency-division multiplexing (OFDM) communication system, a transmitter encodes digital information and modulates it onto an analog carrier signal. Subsequently, a receiver demodulates and decodes the information. In such a system, the receiver should be well synchronized to the transmitter to minimize any performance degradation due to synchronization errors (e.g., time, frequency, and/or phase errors). This sensitivity to synchronization accuracy is especially pronounced in a high signal-to-noise ratio (SNR) environment including, for example, a wired communication system (e.g., a coaxial (“coax”) cable system).

Transceiver synchronization is sensitive to various signal impairments that affect the quality of the transmitted and received signals. Signal impairments may result from non-idealities in the front-ends of the transceivers or in the processing circuits therein. For example, mismatched active and passive elements (e.g., quadrature mixers, filters, digital-to-analog converters, and/or analog-to-digital converters) in the I and Q (in-phase and quadrature) signal paths introduce I/O mismatch impairments in the transmitted and received signals. I/O mismatch, which also may be referred to as I/O offset, is present in both the transmitter and receiver. In another example, carrier frequency offset (CFO) in the receiver, resulting from the difference in carrier frequency at the transmitter and the receiver (e.g., a difference in frequency of local oscillators that provide the carrier frequency in the transmitter and receiver), may impair the received signals. Channel effects (e.g., signal convolution with the channel) may also impair signals.

As services to be delivered over the communication system become more complex and multimedia rich, more data is sent. The complexity, speed, and sensitivity of the communication system are constantly pushed to the limit. Accordingly, there is a need for improved techniques to achieve transceiver timing synchronization and to estimate and compensate for signal impairments such as I/O offsets, CFO, channel effects, and/or other impairments to communication signals.

### BRIEF DESCRIPTION OF THE DRAWINGS

The present embodiments are illustrated by way of example and are not intended to be limited by the figures of the accompanying drawings. Like numbers reference like elements throughout the drawings and specification.

FIG. 1A illustrates a communications system within which some embodiments may be implemented.

FIG. 1B illustrates sources of signal impairment in the communications system of FIG. 1A.

FIG. 2A illustrates a plurality of preamble signals in relation to physical layer frames in the frequency domain in accordance with some embodiments.

FIG. 2B illustrates an exemplary preamble signal in the time domain that is representative of a portion of a preamble signal depicted in FIG. 2A in accordance with some embodiments.

FIG. 3 illustrates a process in which a first portion of an exemplary preamble signal is generated and transformed from the frequency domain to the time domain in accordance with some embodiments.

FIG. 4 illustrates a process in which a second portion of an exemplary preamble signal is generated and transformed from the frequency domain to the time domain in accordance with some embodiments.

FIG. 5 illustrates a process in which a last portion of an exemplary preamble signal is generated and transformed from the frequency domain to the time domain in accordance with some embodiments.

FIG. 6 illustrates a preamble signal coexisting with a plurality of pilot symbols within a physical layer frame in accordance with some embodiments.

FIG. 7 is a functional diagram illustrating a preamble searcher circuit in a receiver in accordance with some embodiments.

FIG. 8 is a flowchart illustrating an exemplary method of searching and utilizing preamble signals at a receiver in accordance with some embodiments.

FIGS. 9A and 9B are flowcharts showing methods of generating signals that include preambles in accordance with some embodiments.

### DETAILED DESCRIPTION

Techniques are disclosed for synchronizing a receiver with a transmitter, and more specifically, for compensating in the receiver for signal impairments introduced in the transmission between the transmitter and the receiver. In some embodiments, the techniques include detecting a preamble signal in a physical layer frame, estimating the signal impairments based on the preamble signal, and compensating for the estimated impairments. The embodiments provided herein enable accurate and low complexity acquisition and synchronization.

In some embodiments, a method of signal generation includes selecting a subset of contiguous OFDM symbols from a set of contiguous OFDM symbols, selecting a subset of contiguous subcarriers from a set of subcarriers, and generating a preamble that occupies the subset of contiguous subcarriers in the subset of contiguous OFDM symbols. The preamble includes portions in respective OFDM symbols of the subset of contiguous OFDM symbols. In the time domain each portion of the preamble corresponds to a repeating sequence of samples when subcarriers outside of the subset of contiguous subcarriers are filtered out. Generating the preamble includes flipping the sign of one or more occurrences of the repeating sequence of samples for a final portion of the preamble in one or more final OFDM symbols of the subset of contiguous OFDM symbols.

In some embodiments, a method of signal generation includes selecting a subset of contiguous OFDM symbols from a set of contiguous OFDM symbols, selecting a subset of contiguous subcarriers from a set of subcarriers, and generating a preamble that occupies the subset of contiguous subcarriers in the subset of contiguous OFDM symbols. The preamble includes portions in respective OFDM symbols of the subset of contiguous OFDM symbols. To generate the preamble, modulation symbols are placed on regularly spaced subcarriers in the subset of contiguous subcarriers within each portion of the preamble, in the frequency domain. The modulation symbols on the regularly spaced subcarriers for a respective portion of the preamble are phase-shifted with respect to the modulation symbols on the regularly spaced subcarriers for a previous portion of the preamble.

In some embodiments, a communications device includes a transmitter to transmit frames on multiple subcarriers. The frames each include multiple contiguous OFDM symbols. A respective frame includes a preamble that occupies a contiguous subset of the multiple subcarriers and includes portions in respective OFDM symbols of a contiguous subset of the multiple contiguous OFDM symbols. In the time domain each portion of the preamble corresponds to a repeating sequence of samples when subcarriers outside of the subset of contiguous subcarriers are filtered out. The sign of one or more occurrences of the repeating sequence of samples is flipped for a final portion of the preamble in one or more final OFDM symbols of the subset of contiguous OFDM symbols.

In some embodiments, a receiver includes a filter to extract samples corresponding to a signal carried on a contiguous group of subcarriers that form a subset of a set of available subcarriers. The receiver also includes a preamble detector to detect a preamble in the extracted samples. The preamble includes a repeating sequence of samples. The receiver further includes a preamble boundary searcher to identify an end of the preamble as indicated by one or more occurrences of the repeating sequence of samples having flipped signs with respect to previous occurrences of the repeating sequence of samples.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims.

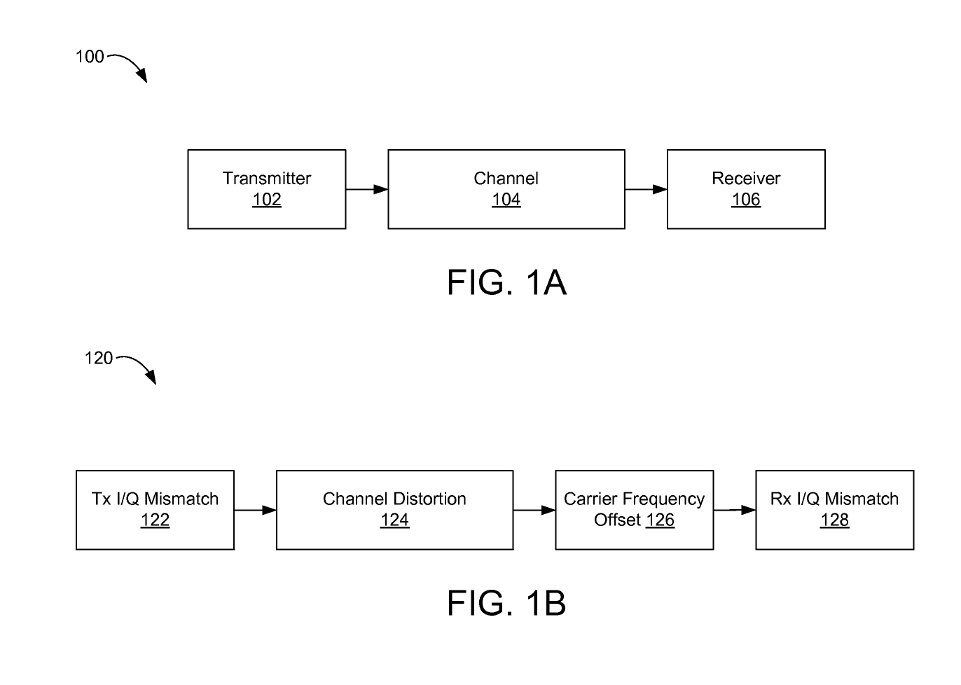

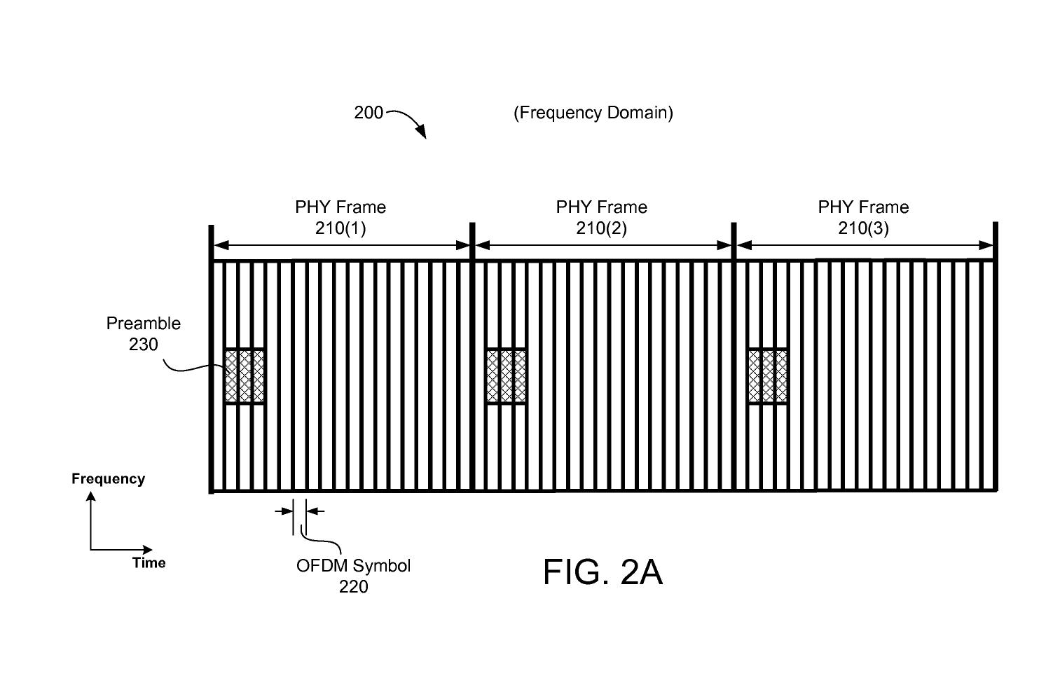

FIG. 1A illustrates a communications system 100 within which the present embodiments may be implemented. The communications system 100 includes a transmitter 102, a channel 104, and a receiver 106. The transmitter 102 may also be referred to a transmitting modem and the receiver 106 may also be referred to as a receiving modem. The transmitter 102 and receiver 106 may be implemented in respective transceivers in respective communication devices. The transmitter 102 transmits data to the receiver 106 over the channel 104, which couples the transmitter 102 with the receiver 106. For example, the transmitter 102 and receiver 106 may be coupled via a coax cable network, a telephone network, or any suitable type of network. In some embodiments, the channel 104 is wireless. The communications system 100 is just one example of a communication system within which the present embodiments may be implemented. Various alternative examples are within the scope of the present embodiments. For example, there may be more than two devices 102 and 106, and there may be intervening devices on the channel 104. In some examples, the transmitter 102 and receiver 106 may be a coax line terminal (CLT) and a coax network unit (CNU), respectively.

FIG. 1B illustrates sources 120 of signal impairment, and thus signal degradation, in the communications system 100 of FIG. 1A. I/O mismatch 122 in the transmitter 102 causes signal impairment, as does I/O mismatch 128 in the receiver 106. The channel 104 introduces channel distortion 124, which may be linear distortion. Carrier frequency offset (CFO) 126 in the receiver 106, which results from the frequency of a local oscillator in the receiver 106 differing from the frequency of a corresponding local oscillator in the transmitter 102, may also cause signal impairment. In some embodiments, channel distortion 124 includes multi-path effects and Additive White Gaussian Noise (AWGN).

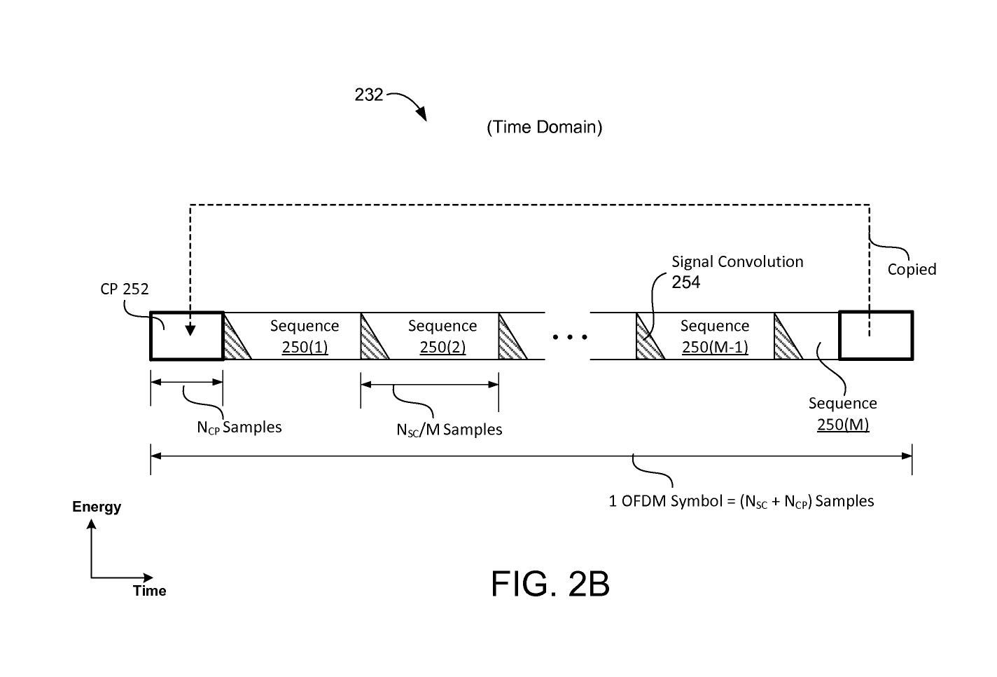

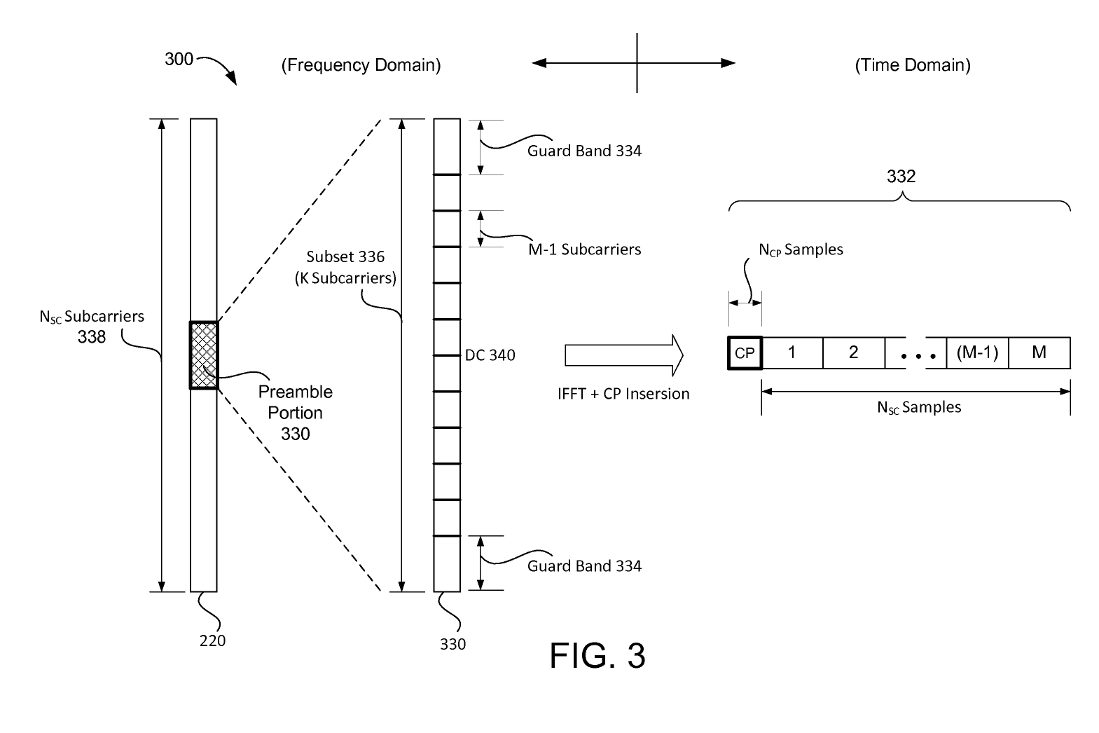

FIG. 2A illustrates a plurality of preamble signals 230 in relation to physical layer (PHY) frames 210 in the frequency domain in accordance with some embodiments. As previously mentioned, the transmitter 102 and receiver 106 communicate over the channel 104 using analog signals, which are converted from and to digital signals. A digital signal 200, as generated by the transmitter 102, may include a series of PHY frames 210(1), 210(2) and 210(3), as shown in FIG. 2A. Each frame 210 may include a preamble signal 230, and may also include other reference signals (e.g., pilot symbols) and other control channels (not shown for simplicity). After generating the digital signal 200, the transmitter 102 converts the digital signal 200 into analog form and transmits it over the channel 104. At the receiver 106, the received signal is digitized and processed using various circuits in the receiver 106 to synchronize the PHY frames 210(1)-210(3) and reliably and efficiently recover data from the PHY frames 210(1)-210(3) for purposes of demodulation and decoding. Although depicted as PHY frames, frames 210(1)-210(3) may be a super-frame or other suitable frame structures.

The synchronization can be generally categorized into time synchronization and frequency synchronization. For purposes of discussion herein, time synchronization may include PHY frame synchronization and OFDM symbol synchronization. Frequency synchronization may include carrier frequency synchronization and sampling frequency synchronization. Synchronization accuracy is of particular importance when the transceivers operate in a high signal-to-noise ratio (SNR) environment including, for example, a wired (e.g., coax cable) communication system.

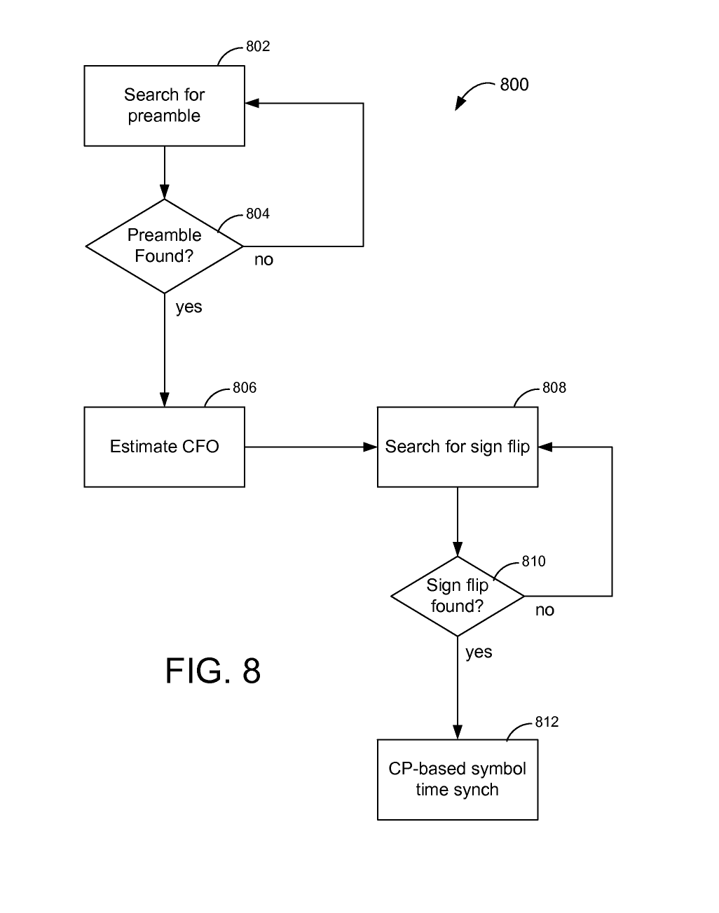

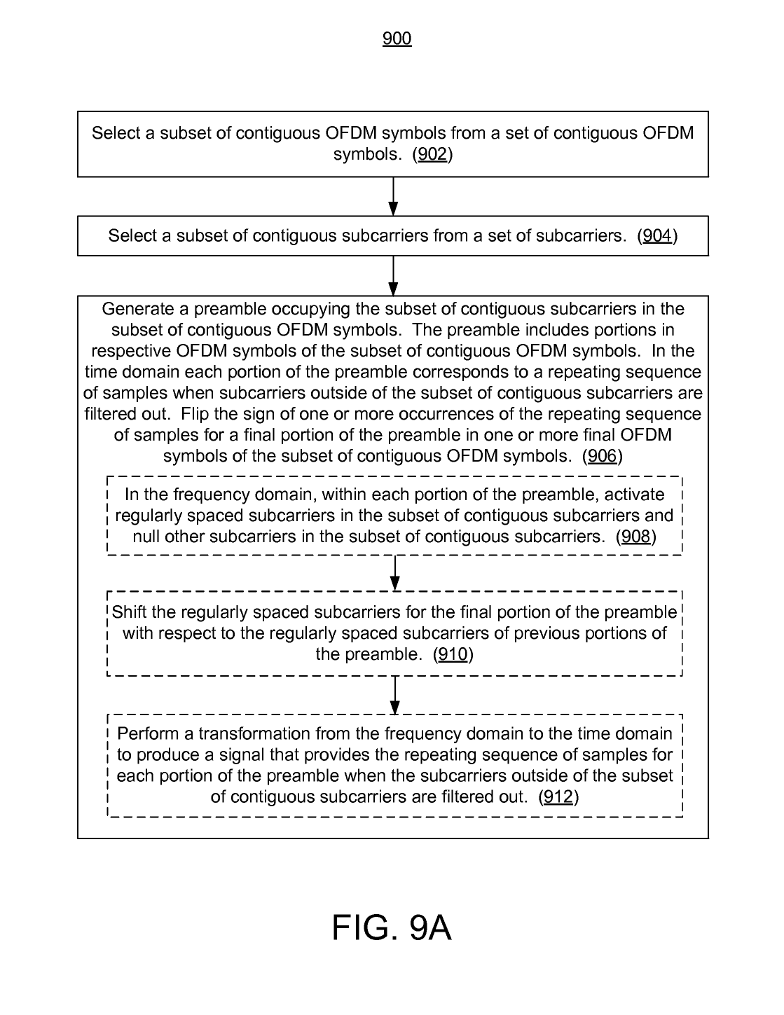

As is further discussed in detail in relation to FIGS. 7 and 8, typically one or more reference signals, including the preamble 230, are provided in the PHY frames 210(1)-210(3) in order to facilitate synchronization operations. The synchronization operations may include two phases: (1) an acquisition phase, and (2) a tracking phase. The acquisition phase is performed, for example, at system startup to achieve PHY frame synchronization, so that the start of a PHY frame 210 may be correctly located. The acquisition phase may also be utilized to recover a coarse-level CFO, so that the carrier frequency error may be reduced to within a fraction of subcarrier spacing. During normal operation, the tracking phase is performed to achieve a finer-level OFDM symbol synchronization, a finer-level CFO recovery, and carrier phase tracking.

In accordance with one or more embodiments, each of the PHY frames 210 (e.g., frames 210(1), 210(2), and 210(3)) includes a plurality of OFDM symbols 220. The preamble signal 230 in each of the PHY frames 210 is a narrowband signal that functions as one of the available reference signals. As shown in FIG. 2A, each OFDM symbol 220 is depicted as occupying the full range of frequencies (or subcarriers) available. According to some embodiments, the preamble signal 230 occupies a subset of the overall available subcarriers, hence the name “narrowband preamble.”

Further, the preamble signal 230 is depicted in FIG. 2A as temporally spanning three OFDM symbols 220. It is noted that the preamble signal 230 may occupy any number of OFDM symbols 220 to have a temporal length suitable for the application. However, according to the embodiments provided herein, the preamble signal 230 is not a continuous signal, and therefore the preamble signal 230 is not present in each OFDM symbol 220. The preamble signal 230 in the example of FIG. 2A is periodically transmitted in a few selected OFDM symbols 220 (e.g., the three OFDM symbols 220, a portion of which are used for the preamble signal 230) in each PHY frame 210.

FIG. 2B illustrates an exemplary preamble signal portion 232 in the time domain that is representative of a portion of a preamble signal 230 depicted in FIG. 2A in accordance with some embodiments. The preamble signal portion 232 has a temporal length of a single OFDM symbol; this length corresponds to a number N_{SC} of samples plus a number N_{CP} of cyclic prefix samples.

According to some embodiments, the preamble signal portion 232 is configured and constructed in a way that, after band-pass or low-pass filtering (more details of which are described regarding FIGS. 7-8), the preamble signal portion 232 is periodic or repeating. The preamble signal portion 232 includes a number M of sequences 250(1)-250(M). Each of the sequences 250(1)-250(M) includes N_{SC}/M samples and has a corresponding temporal length. Each of the sequences 250(1)-250(M) carries the same data in its N_{SC}/M samples. The preamble signal portion 232 is therefore periodic (or repeating). Note that, for each of the sequences 250(1)-250(M), signal convolution 254 with the channel 104 (as depicted in the shaded triangles) results in the same pattern of deterioration. The periodic structure (or periodicity) of the sequences 250(1)-250(M) is therefore not adversely affected by the signal convolution 254. The periodic structure of the preamble signal portion 232 may be used by the receiver 106 to perform carrier frequency offset (CFO) estimation (e.g., estimation of CFO 126, FIG. 1B) and receiver I/O mismatch estimation (e.g., estimation of Rx I/O Mismatch 128, FIG. 1B) by comparing the phase rotation between two successive sequences 250 (e.g., sequences 250(1) and 250(2)) as well as observing other signal degradations among the sequences 250(1)-250(M). Among others, one benefit of the exemplary preamble signal portion 232 may be that all the energy coming from the channel 104 can be used to perform these estimations based on the preamble signal portion 232, and therefore a conventional multi-finger correlation may not be necessary.

In one or more embodiments, the last N_{CP} samples of the last sequence 250(M) may be copied and appended to the front of the first sequence 250(1) to complete the OFDM symbol. The copied portion is referred to as cyclic prefix (CP) 252, and N_{CP} is the CP length. The CP 252 may provide support to mitigate inter-symbol interference (ISI) caused by frequency-selective fading, or to perform symbol synchronization and some limited CFO estimation. It is noted that, in the embodiment of FIG. 2B, N_{CP} is not limited to the length of the sequence 250(M). In other embodiments deployed in other types of communication environments including, for example, a wireless network, the copied portion may have a different length limitation on N_{CP}.

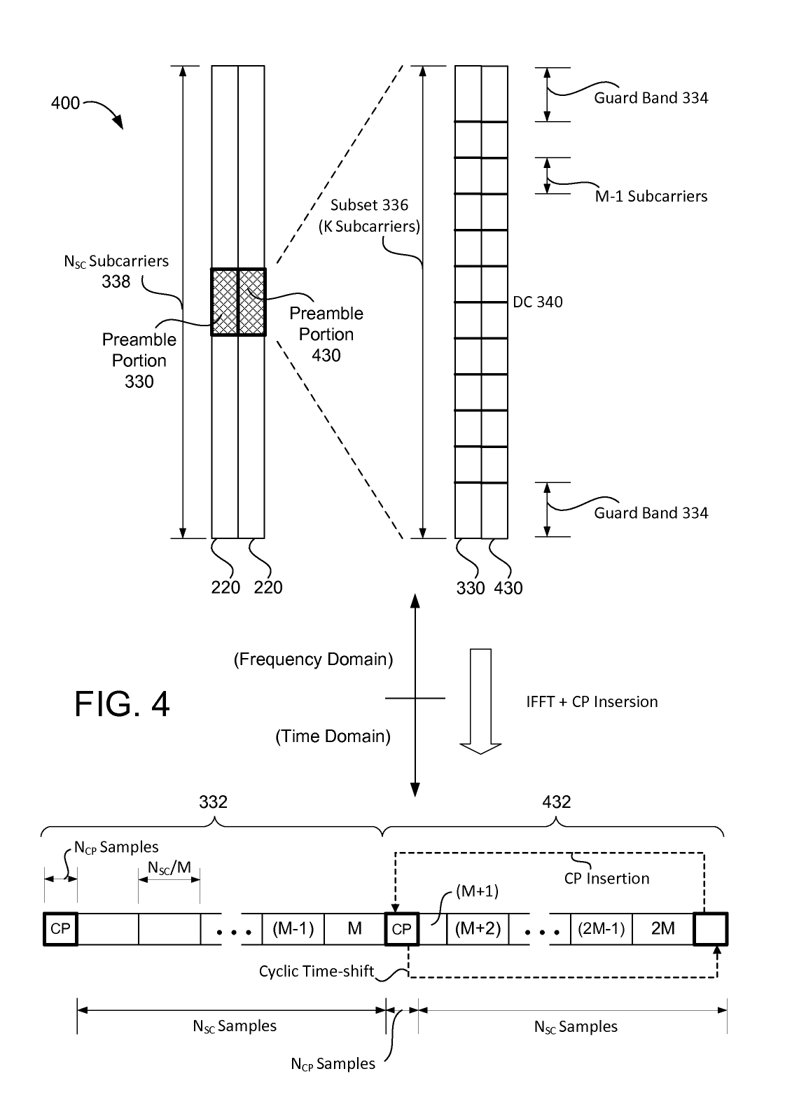

FIG. 3 illustrates a process 300 in which a first frequency-domain preamble portion 330 (e.g., a first portion of a preamble signal 230, FIG. 2A) is generated and transformed from the frequency domain to the time domain in accordance with some embodiments. The first frequency-domain preamble portion 330 is included in a first OFDM symbol 220. The transformation from the frequency domain to the time domain is typically performed by an inverse fast Fourier transformer (IFFT) (not shown for simplicity) within the transmitter 102. In some embodiments, the preamble signal that includes the first frequency-domain preamble portion 330 spans a plurality of OFDM symbols. However, in other embodiments, the first frequency-domain preamble portion 330 may be a complete preamble signal.

As shown in FIG. 3, the preamble (and thus the first frequency-domain preamble portion 330 thereof) occupies only a subset 336 of all the N_{SC} available subcarriers 338, and therefore is a narrow-band preamble. The subset 336 includes K subcarriers. In accordance with some embodiments, one subcarrier out of every M subcarriers in the subset 336 (excluding subcarriers in guard bands 334 at both ends of the subset 336) is selected to provide the temporally periodic structure with M repetitions (e.g., M repetitions of the sequence 250(1) through 250(M), FIG. 2B) in a first time-domain preamble portion 332 (e.g., the preamble signal portion 232, FIG. 2B). The selected subcarriers are periodic and thus regularly spaced, as shown in FIG. 3. The selected subcarriers are activated by placing known modulation symbols on them. The remaining (M−1) number of subcarriers out of every M subcarriers that are not selected are nullified (i.e., nulled).

The first time-domain preamble portion 332 results from transformation of the first frequency-domain preamble portion 330 from the frequency domain to the time domain and CP insertion. The first time-domain preamble portion 332 is an example of the preamble signal portion 232, FIG. 2B. In practice, the entire OFDM symbol 220 may be transformed from the frequency domain to the time domain. The resulting time-domain signal provides the first time-domain preamble portion 332 when subcarriers 338 outside of the subset 336 are filtered out.

In some embodiments, the selected subcarriers are symmetrical about a direct current (DC) subcarrier 340. It is noted that the selected subcarriers for the preamble signal need not be symmetrical about the DC subcarrier 340. For embodiments in which the selected subcarriers are not symmetrical about the DC subcarrier 340, a band-pass filter and a down-conversion circuit may be used instead of a low-pass filter in the preamble searcher circuit 700 (FIG. 7) in the receiver 106 to extract the preamble signal.

Because of filter imperfection (e.g., in the search path filter 720, FIG. 7), guard bands 334 are used on the two edges representing the highest and lowest of the subcarrier frequencies in the subset 336. Subcarriers inside the guard bands 334 are nullified and not used to transmit the preamble signal. After the first frequency-domain preamble portion 330 is mapped (e.g., by a well-known symbol-to-subcarrier mapper, not shown for simplicity), transformed from the frequency domain to the time domain by an IFFT, and inserted with a cyclic prefix, (e.g., by a well-known CP generator, not shown for simplicity), the resulting signal is the first time-domain preamble portion 332, which has a similar structure to that of the preamble signal portion 232 (FIG. 2B).

In one or more embodiments, because the (M−1) number of subcarriers out of every M subcarriers are nullified, the transmitter 102 may boost the power of modulation symbols (e.g., QAM symbols) placed on the selected subcarriers in the subset 336, to compensate for the energy loss caused by nullification. For example, if M=2 represents a 3 dB energy loss in the transmission of the preamble signal, the transmitter may compensate for this loss by increasing the power on the selected subcarriers by 3 dB.

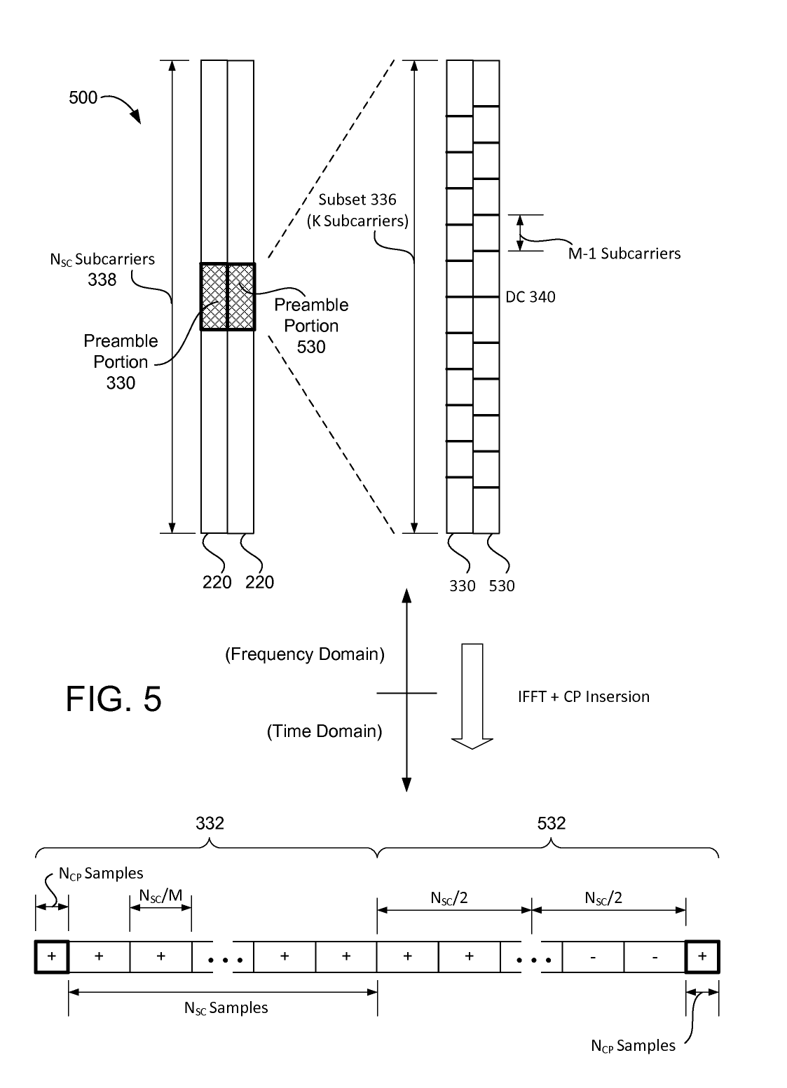

FIG. 4 illustrates a process 400 in which a second frequency-domain preamble portion 430 (e.g., a second portion of a preamble signal 230, FIG. 2A) is generated and transformed from the frequency domain to the time domain in accordance with some embodiments. The second frequency-domain preamble portion 430 may be transformed in a similar manner as the first frequency-domain preamble portion 330, to form a second time-domain preamble portion 432 of the preamble signal. The second time-domain preamble portion 432 is preceded by the first time-domain preamble portion 332 in the preamble signal. However, because the CP insertion is only performed after the IFFT, if the same process as process 300 is performed on the second frequency-domain preamble portion 430, then the resulting second time-domain preamble portion 432 would have the exact same structure as the first time-domain preamble portion 332. The periodicity established in the first time-domain preamble portion 332 would therefore be discontinued because of the CP portion of the signal 432. Depending on the application, it may be desirable to continue the periodic structure (i.e., periodicity) already established in the first time-domain preamble portion 332.

According to some embodiments, a cyclic time-shift is applied to maintain the periodic structure of the preamble signal across multiple OFDM symbols. The cyclic time-shift may be applied to the second frequency-domain preamble portion 430 by multiplying the modulation (e.g., QAM) symbols contained within the first frequency-domain preamble portion 330 with a phase ramp and using the resulting modulation symbols in the second frequency-domain preamble portion 430. The modulation symbols on the selected subcarriers in the second frequency-domain preamble portion 430 thus are phase-shifted with respect to the modulation symbols on the selected subcarriers in the first frequency-domain preamble portion 330. This multiplication may be represented in the following equation:

pₙ₊₁(f)=pₙ(f)×exp(j2πfN_{CP}/N_{SC}), (Eq. 1)

where p stands for a modulation symbol (e.g., QAM symbol) on a selected subcarrier in the subset 336, n represents the index of the OFDM symbol 220, f is the subcarrier index, and the item (j2πfN_{CP}/N_{SC}) represents the phase shift.

As illustrated in FIG. 4, the effect of the cyclic time-shift is to shift the N_{CP} number of samples at the head portion of the N_{SC} samples in the second time-domain preamble portion 432 to the tail portion of the N_{SC} samples. In this way, when the CP is inserted, those N_{CP} number of samples that were shifted to the tail portion of the signal 432 are copied back to the head portion of the signal 432, thereby continuing the periodicity of the first time-domain preamble portion 332 in the second time-domain preamble portion 432. In some embodiments, this cyclic time-shifting technique may be adjusted and employed on a per-OFDM-symbol basis for continuing the periodicity of preamble symbols that span more than two OFDM symbols 220.

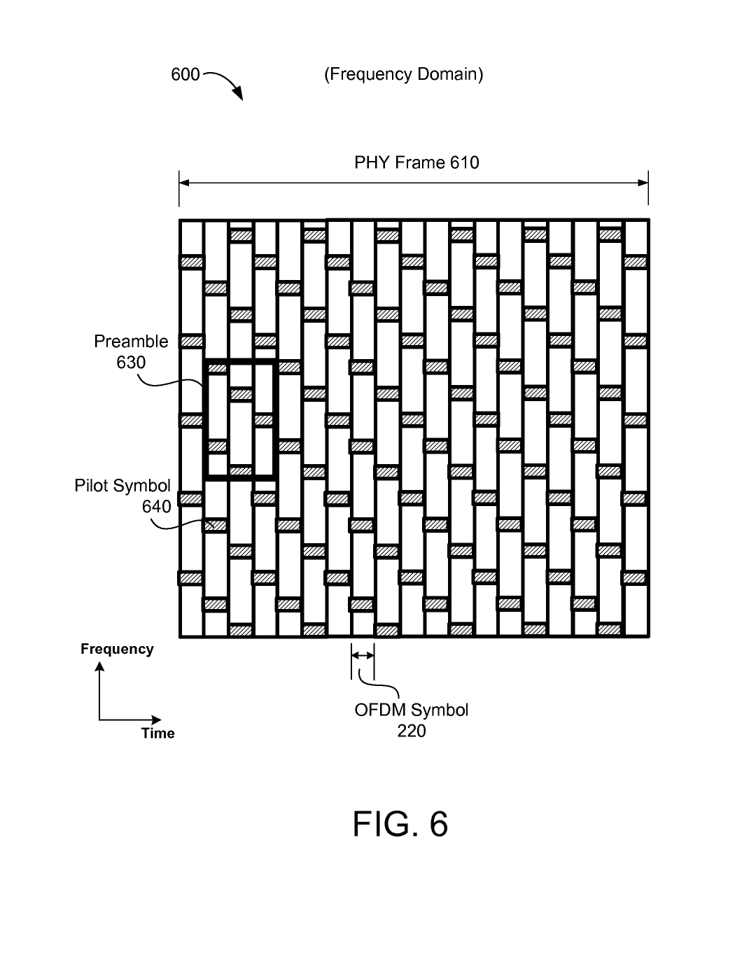

FIG. 5 illustrates a process 500 in which a last frequency-domain preamble portion 530 (e.g., a last portion of a preamble signal 230, FIG. 2A) is generated and transformed from the frequency domain to the time domain in accordance with some embodiments. While the last frequency-domain preamble portion 530 is shown as immediately following the first frequency-domain preamble portion 330 in FIG. 5, these two portion may be separated by one or more other portions (e.g., by one or more instances of the second frequency-domain preamble portion 430, FIG. 4), each of which corresponds to a distinct OFDM symbol 220. For example, the preamble portions 330 (FIG. 3), 430 (FIG. 4) and 530 together may represent a complete preamble signal, such as the preamble signal 230 (FIG. 2A). A complete preamble signal may include a combination of any suitable numbers of the preamble portions 330, 430, and 530.

The last frequency-domain preamble portion 530 may be transformed in a similar manner as the second frequency-domain preamble portion 430 (FIG. 4) to form a last time-domain preamble portion 532. The last time-domain preamble portion 532 is preceded by the first time-domain preamble portion 332 in the preamble signal. While note shown in FIG. 5, the preamble signal may include one or more instances of the second time-domain preamble portion 432 (FIG. 4) between the first time-domain preamble portion 332 and the last time-domain preamble portion 532.

However, in some embodiments, a 180-degree phase rotation (which results in a sign flip in the time domain) may be performed on one or more sequences (e.g., one or more of the sequences 250(1) through 250(M), FIG. 2B) in the last time-domain preamble portion 532 (e.g., at the end of the last time-domain preamble portion 532) in order to facilitate frame synchronization. For example, before the last frequency-domain preamble portion 530 is transformed from the frequency domain to the time domain, a shift of the grid of selected subcarriers in the last frequency-domain preamble portion 530 is performed with respect to the grid of selected subcarriers in previous frequency-domain portions of the preamble (e.g., including the first frequency-domain preamble portion 330). As a result, a second half (N_{SC}/2) of samples in the last time-domain preamble portion 532 are sign-flipped. In another embodiment (not shown in FIG. 5), a suitable phase rotation may be performed (e.g., by shifting the grid of selected subcarriers in the final frequency-domain preamble portion 530) so that the entire N_{SC} and N_{CP} samples contained within the last time-domain preamble portion 532 are sign-flipped for frame synchronization purposes. In some embodiments, one or more sequences may have their sign flipped in one or more time-domain preamble portions 432 that immediately precede the last time-domain preamble portion 532, as well as in the last time-domain preamble portion 532.

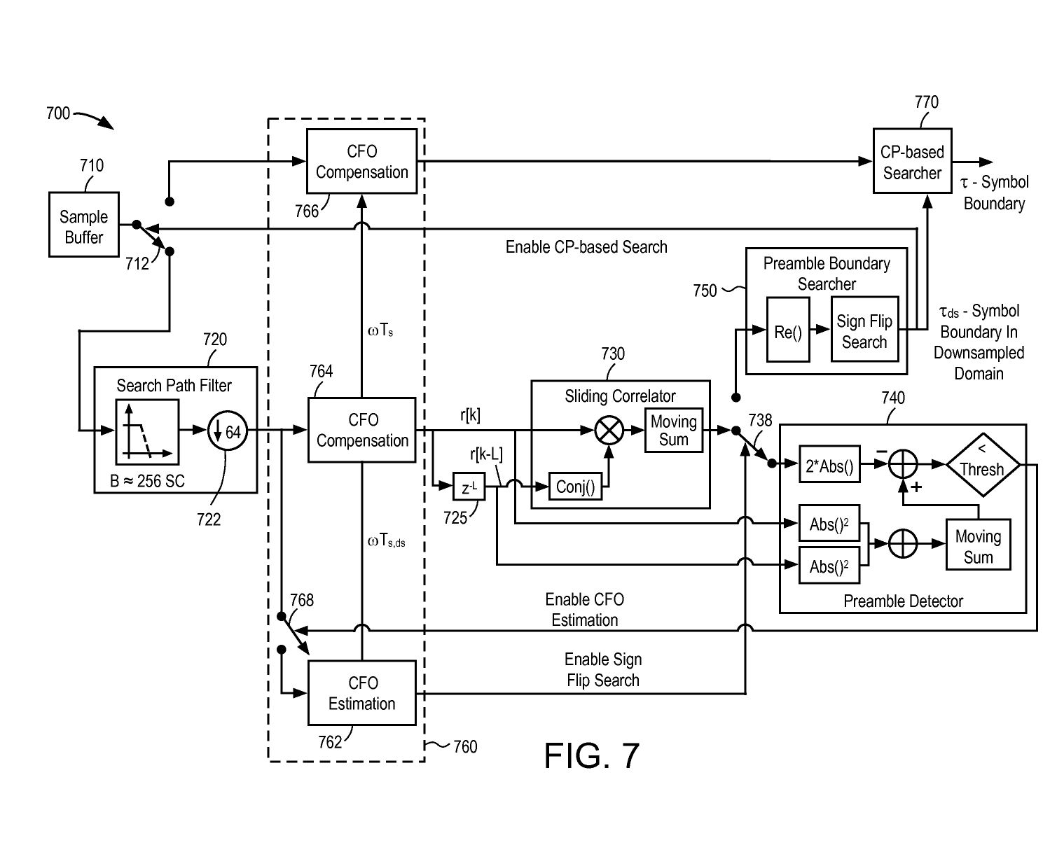

Transmissions in communication systems such as the system 100 (FIG. 1A) may include a plurality of well-known reference signals in addition to the data-bearing subcarriers. FIG. 6 shows a graph 600 that illustrates a preamble signal 630 coexisting with a plurality of pilot symbols 640 within a PHY frame 610 (e.g., one of the PHY frames 210(1) through 210(3), FIG. 2A). Pilot symbols 640 may be part of a staggered or continual pilot structure (the pilot symbols 640 of FIG. 6 are shown as staggered), and they are also transmitted by the transmitter 102 for purposes of synchronization and channel estimation and tracking. In particular, pilot symbols are especially useful for channel estimation over the full bandwidth of the system, and therefore many embodiments disclosed herein may employ both pilot symbols and preamble signals. As illustrated in FIG. 6, a staggered pilot structure of pilot symbols 640 sparsely occupies a plurality of subcarriers. Accordingly, when a system employs pilot symbols as well as a preamble signal such as disclosed herein, in some situations the range of subcarriers selected for the preamble signal may overlap with those selected for the pilot symbols.

As previously described, the preamble signals of one or more embodiments select one out of every M subcarriers for preamble signal transmission, and nullify the (M−1) subcarriers that are not selected. However, for those embodiments that employ both pilot symbols 640 and the preamble signal 630, depending on the situation, it may not be necessary to nullify those pilot symbols 640 on subcarriers within the preamble signal 630 (i.e., those pilot symbols 640 that fall within the preamble signal 630). For example, if a respective pilot symbol 640 is present in the preamble signal 630, but the respective pilot symbol is not on the one or more subcarriers that are selected for preamble signal transmission, then the transmitter leaves the respective pilot symbol 640 in place. Some preamble signal quality degradation may be observed because of the pilot symbols 640 within the preamble signal 630. The receiver 106 is configured to tolerate the degradation of preamble signal quality that results from the overlapping of pilot symbols 640 with the preamble signal 630.

If a respective pilot symbol 640 is present in the preamble signal 630, and the respective pilot symbol 640 overlaps with the one or more subcarriers that are selected for preamble signal transmission (i.e., is on one of the selected subcarriers), then the transmitter 102 may be configured to either (1) overwrite the preamble signal 630 with the pilot symbol 640, or (2) overwrite the pilot symbol 640 with the preamble signal 630. In the former case, the modulation symbol in the preamble signal 630 that overlaps with the pilot symbol 640 is replaced with the pilot symbol 640. In the latter case, the pilot symbol 640 is replaced with the modulation symbol with which it overlaps in the preamble signal 630. Each approach may insert signal distortion that affects the overall functionality of the overwritten signals, and different approaches may be selected in different embodiments.

FIG. 7 is a functional diagram illustrating a preamble searcher circuit 700 which may be implemented within the receiver 106 (FIG. 1A) in accordance with some embodiments. FIG. 8 is a flowchart illustrating an exemplary method 800 of searching for and utilizing the preamble signals at the receiver 106 in accordance with some embodiments. As discussed above, the preamble signals provided herein may function as reference signals in order to facilitate the receiver 106 to achieve synchronization with the transmitter 102. The synchronization, which the preamble searcher circuit 700 may perform, can be generally categorized into an acquisition phase and a tracking phase. In some embodiments, the detection of the preamble signals in the receiver 106 may be performed without any knowledge of the specific preamble sequence. This technique is known as “blind detection” or “non-coherent” detection, and is especially useful in systems where a preamble sequence is not expressly specified (e.g., in wired communication systems, or wireless local area networks). In particular, in many implementations, the preamble signal may be detected by performing a maximum-likelihood computation over two consecutive preamble periods of length L using a likelihood metric L₁[k], which may be expressed as:

L₁[k]=|Φᵣᵣ[k]|−(Pᵣᵣ[k])/2, (Eq. 2)

where Φᵣᵣ[k] is the correlation value, and Pᵣᵣ[k] represents the energy detected.

The correlation function Φᵣᵣ[k] may be expressed as:

Φᵣᵣ[k]=Σᵢ₌₀^{L-1}r*[k+i]·r[L+k+i], (Eq. 3)

where k represents the sample index, r stands for received samples, and L is the duration of a single period (e.g., the period of sequences 250(1) through 250(M), FIG. 2B) or an integer multiple thereof. For example, L may be N_{SC}/M, 2N_{SC}/M, and so forth.

And, the energy function Pᵣᵣ[k] may be expressed as:

Pᵣᵣ[k]=Σᵢ₌₀^{L-1}|r[i]|²+|r[L+i]|². (Eq. 4)

According to some embodiments, the preamble signals may be detected when the likelihood metric as provided in Eq. 2 shows a transition from a relatively low value to a relatively high value. In some alternative embodiments, the likelihood metric may be inversed, and the preamble signals may be detected when the likelihood metric shows a transition from a relatively high value to a relatively low value.

After the preamble signals are detected, carrier frequency offset (CFO) estimation and frame boundary detection may be performed based on the preamble signals. In one or more embodiments, the CFO estimation and boundary detection may be based on observing the phase of the correlation function Φᵣᵣ[k] (Eq. 3). For purposes of CFO estimation and frame boundary detection, L is preferably selected to be the duration of a single period. Nonetheless, depending on the embodiments, correlations over multiple periods may be accumulated to increase CFO estimation accuracy. The CFO estimation may be based on the actual correlation phase. The amount of the CFO detected is directly proportional to the phase deviation between two sequential preamble signals. As previously mentioned, frame boundary detection may be achieved by detecting a 180-degree phase rotation (i.e., a sign flip). In one or more embodiments, the CFO estimation is performed before the frame boundary detection, and therefore no sign-flip is assumed during the CFO estimation. Likewise, in some embodiments, the frame boundary detection is performed after the CFO estimation, and therefore no CFO is assumed during the boundary detection.

In some embodiments, other types of signal distortion may be estimated and compensated based on the preamble signals in addition to the above-mentioned CFO. These other types of signal distortion may include, for example, multi-path effects, I/O mismatches, and so forth.

With simultaneous reference to FIGS. 7 and 8, the structure of the preamble searcher circuit 700 and the details on how the preamble searcher circuit 700 may perform these two phases of synchronization based on the preamble signals by employing the method 800 are described below.

The preamble searcher circuit 700 includes a search path filter 720, a sliding correlator 730, a preamble detector 740, and a preamble boundary searcher 750. The receiver 106 (FIG. 1A) converts an analog signal received from the channel 104 (FIG. 1A) into digital samples. The searcher circuit 700 may optionally include a sample buffer 710, which may receive and buffer these samples.

At the beginning of the acquisition phase (e.g., when the system is first turned on), the preamble searcher circuit 700 searches for the preamble signal among the samples received in the sample buffer 710 (802). To perform the search, the samples are first filtered by the search path filter 720, which at this time is coupled to the sample buffer by a switch 712. The search path filter 720 may be a low-pass filter, a band-pass filter, or any suitable type of filter that is configured to extract the preamble signals (e.g., to extract the K subcarriers in the subset 336 from the N_{SC} subcarriers 338, FIGS. 3-5). As previously mentioned, for the embodiments in which the selected subcarriers are symmetrical about the DC subcarrier 340, the search path filter 720 may include a low-pass filter. For the embodiments in which the selected subcarriers are not symmetrical about the DC subcarrier 340, the search path filter 720 may include a band-pass filter and other suitable circuits to extract the preamble signal. The search path filter 720 may also include a decimator 722.

Because the preamble has not yet been found (804—No) at this point in the acquisition phase, there is not yet any CFO estimation or compensation. The samples extracted by the search path filter 720 are therefore sent directly to the sliding correlator 730, without being adjusted by a CFO compensation module 764 coupled between the search path filter 720 and the sliding correlator 730. The sliding correlator 730 calculates the correlation function Φᵣᵣ[k] of Eq. 3. Two samples are provided to the sliding correlator 730 in a given cycle: a sample r[k] and a sample r[k−L] that has been delayed by L cycles by a delay stage 725. (While FIG. 7 shows the delay stage as being separate from the sliding correlator 730, it may be included within the sliding correlator 730.) The sliding correlator 730 takes the complex conjugate (“Conj( )”) of r[k−L] and then multiplies r*[k−L] by r[k] using a mixer. The output of the mixer is provided to an integrator that calculates a moving sum and outputs Φᵣᵣ. [k], in accordance with Eq. 3.

The samples r[k] and r[k−L] as well as the output Φᵣᵣ[k] of the sliding correlator 730 are delivered to the preamble detector 740 through a switch 738, which selectively couples the sliding correlator 730 to the preamble detector 740. The preamble detector 740 includes circuitry to perform energy calculations on the received samples by calculating the energy function Pᵣᵣ[k] (Eq. 4). To calculate Pᵣᵣ[k], the preamble detector determines the squared magnitude (“Abs( )²”) of the samples r[k] and r[k−L], adds the squared magnitudes of these two samples using a combiner, and generates a moving sum using an integrator. The moving sum output by the integrator is Pᵣᵣ[k], in accordance with Eq. 4.

The preamble detector 740 determines a likelihood metric based on the energy function Pᵣᵣ[k] and the correlation function Φᵣᵣ. [k], and determines if any preamble signal is received based on the likelihood metric. In the example of FIG. 7, the preamble detector 740 determines a likelihood metric L₂[k], which equals the likelihood metric L₁[k] of Eq. 2 multiplied by −2:

L₂[k]=(Pᵣᵣ[k])−2|Φᵣᵣ[k]| (Eq. 5).

To determine the likelihood metric L₂[k], the preamble detector 740 determines a value equal to twice the magnitude (2*Abs( )) of the correlation function Φᵣᵣ[k], and uses a combiner to subtract this value from the energy function Pᵣᵣ[k]. The output of the combiner is the likelihood metric L₂[k].

In the example depicted in FIG. 7, the preamble detector 740 is thus configured so that the preamble signals are detected when the likelihood metric L₂[k] shows a transition from a relatively high value to a relatively low value (as opposed to a transition from a relatively low value to a relatively high value for the likelihood metric L₁[k]). As such, if the value of the likelihood metric L₂[k] drops below a predetermined threshold, then the preamble detector 740 determines that a preamble signal is found (804—Yes). The preamble detector 740 asserts an “Enable CFO Estimation” signal in response to determining that a preamble signal has been found.

After the preamble is found (804—Yes), the preamble searcher circuit 700 directs the samples (which are samples of the preamble signal) from the search path filter 720 to CFO estimation and compensation circuitry 760 in the receiver 106. The CFO estimation and compensation circuitry 760 may estimate (806) and compensate for CFO based on the preamble signals in the manner described above. A switch 768 closes in response to assertion of the “Enable CFO Estimation” signal, thereby coupling the output of the search path filter 720 to the input of a CFO estimation module 762, which estimates (806) the CFO. In addition to the CFO estimation module 762, the CFO estimation and compensation circuitry 760 includes a CFO compensation module 764 coupled between the search path filter 720 and the sliding correlator 730, and a CFO compensation module 766 that is selectively coupled to the sample buffer 710 by the switch 712. The CFO compensation modules 764 and 766 compensate for the estimated CFO (ωTₛ and ωT_{s,ds}) as determined by the CFO estimation module 762. In many embodiments, CFO estimation and compensation circuitry 760 may include other types of modules to compensate other types of signal distortions including, for example, multi-path effects, I/O mismatches, and so forth.

After the preamble is found, the preamble searcher circuit 700 may also start to search for the frame boundary by searching for the sign-flip (808). At this stage, the correlation results (e.g., the values of the correlation function Φᵣᵣ[k], Eq. 3) from the correlator 730 are redirected to the preamble boundary searcher 750, which looks for the 180-degree phase change (i.e., the sign flip) among the samples it receives. For example, the CFO estimation module 762 asserts an “Enable Sign Flip Search” signal upon generating a CFO estimate. In response to assertion of the “Enable Sign Flip Search” signal, the switch 738 couples the output of the sliding correlator 730 to the input of the preamble boundary searcher 750. The preamble boundary searcher 750 determines the real portion (“Re( )”) of this input and then searches (808) for the sign flip. (In the embodiment illustrated in FIG. 7, the preamble boundary searcher 750 is a different circuit than the preamble detector 740. However, in other embodiments, the preamble boundary searcher 750 and preamble detector 740 may be the same circuit. In these embodiments, separate sets of parameters may be supplied to the same circuit in order to perform different tasks.)

If the preamble boundary searcher 750 finds the sign-flip (810—Yes), it determines that the boundary of the preamble signal (or an OFDM symbol at or near the end of the preamble signal) is found, and that the acquisition phase is to be transferred into the tracking phase. (If the preamble boundary searcher 750 does not find the sign-flip (810—No), it continues to search (808) for the sign flip.) The CFO estimate as determined during the acquisition phase is applied to compensate signal distortions during the tracking phase. For example, the preamble boundary searcher 750 asserts an “Enable CP-based Search” signal in response to finding the sign-flip. In response, the switch 712 couples the sample buffer 710 to the CFO compensation module 766. The CFO compensation module 766 performs CFO compensation for the samples from the sample buffer 710, based on the estimated CFO (ωTₛ) provided by the CFO estimation module 762, and provides the compensated samples to a CP-based searcher 770. Also, the preamble boundary searcher 750 provides to the CP-based searcher 770 a value τ_{ds} indicating the boundary in the down-sampled domain of the last OFDM symbol carrying the preamble. The CP-based searcher 770 uses the value τ_{ds} to perform a CP-based search for OFDM symbol boundaries at times τ. Thus, during the tracking phase, the preamble searcher circuit 700 continues to perform finer-level time synchronization based, for example, on CP processing (812).

Attention is now directed to methods of generating signals that include preambles.

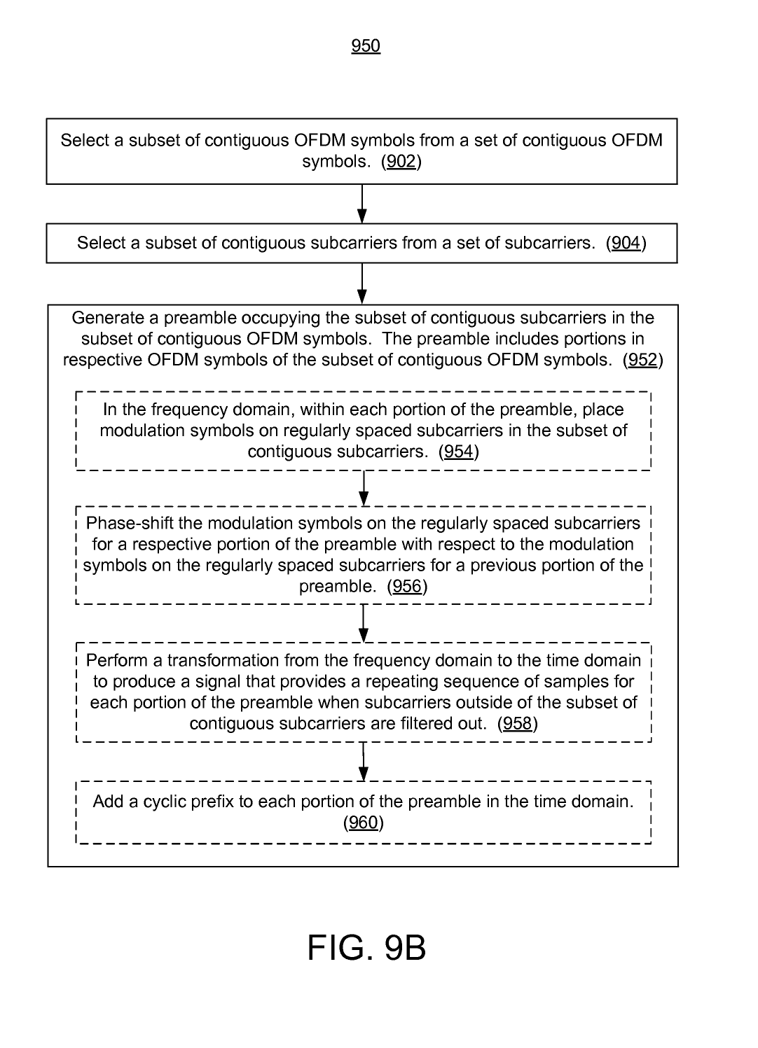

FIG. 9A is a flowchart showing a method 900 of generating a signal that includes a preamble in accordance with some embodiments. The method 900 is performed in the transmitter 102 (FIG. 1A).

In the method 900, a subset of contiguous OFDM symbols (e.g., the second, third, and fourth OFDM symbols 220 in the PHY frame 210(1), 210(2), or 210(3), FIG. 2A) is selected (902) from a set of contiguous OFDM symbols (e.g., the OFDM symbols 220 that compose the PHY frame 210(1), 210(2), or 210(3), FIG. 2A). A subset of contiguous subcarriers (e.g., the subset 336, FIGS. 3-5) is selected (904) from a set of subcarriers (e.g., the N_{SC} subcarriers 338, FIGS. 3-5).

A preamble (e.g., a preamble signal 230, FIG. 2A) is generated (906) that occupies the subset of contiguous subcarriers in the subset of contiguous OFDM symbols. The preamble includes portions in respective OFDM symbols of the subset of contiguous OFDM symbols. In the time domain each portion of the preamble corresponds to a repeating sequence (e.g., the repeating sequence 250(1)-250(M), FIG. 2B) of samples when subcarriers outside of the subset of contiguous subcarriers are filtered out. The sign of one or more occurrences of the repeating sequence of samples is flipped for a final portion of the preamble in one or more final OFDM symbols of the subset of contiguous OFDM symbols (e.g., as shown in and described with respect to FIG. 5).

In some embodiments, to generate the preamble, regularly spaced subcarriers (e.g., with the 1/M spacing shown in FIGS. 3-5) in the subset of contiguous subcarriers are activated (908) within each portion of the preamble in the frequency domain. Modulation symbols (e.g., QAM symbols) are placed on the regularly spaced subcarriers to activate them. Other subcarriers (e.g., the M−1 subcarriers separating each pair of regularly spaced subcarriers, FIGS. 3-5) in the subset of contiguous subcarriers are nulled (i.e., nullified). The nulled subcarriers may include subcarriers in guard bands 334 (FIGS. 3-5) at the ends of the subset of contiguous subcarriers. The regularly spaced subcarriers for the final portion of the preamble are shifted (910) with respect to the regularly spaced subcarriers of previous portions of the preamble, to introduce the sign flip (e.g., as shown in FIG. 5). A transformation from the frequency domain to the time domain (e.g., an IFFT, FIGS. 3-5) is performed (912) to produce a signal that provides the repeating sequence of samples for each portion of the preamble when the subcarriers outside of the subset of contiguous subcarriers are filtered out. A CP may be added to each portion of the preamble in the time domain.

The method 900 may further include placing one or more pilot symbols (e.g., pilot symbols 640, FIG. 6) in the preamble.

FIG. 9B is a flowchart showing a method 950 of generating a signal that includes a preamble in accordance with some embodiments. The method 950 is performed in the transmitter 102 (FIG. 1A).

In the method 950, a subset of contiguous OFDM symbols is selected (902) from a set of contiguous OFDM symbols and a subset of contiguous subcarriers is selected (904) from a set of subcarriers, as described for the method 900 (FIG. 9A).

A preamble (e.g., a preamble signal 230, FIG. 2A) is generated (952) that occupies the subset of contiguous subcarriers in the subset of contiguous OFDM symbols. The preamble includes portions in respective OFDM symbols of the subset of contiguous OFDM symbols.

In some embodiments, to generate the preamble, modulation symbols (e.g., QAM symbols) are placed (954) on regularly spaced subcarriers (e.g., with the 1/M spacing shown in FIGS. 3-5) in the subset of contiguous subcarriers within each portion of the preamble, in the frequency domain. Other subcarriers (e.g., the M−1 subcarriers separating each pair of regularly spaced subcarriers, FIGS. 3-5) in the subset of contiguous subcarriers besides the regularly spaced subcarriers may be nulled. The nulled subcarriers may include subcarriers in guard bands 334 (FIGS. 3-5) at the ends of the subset of contiguous subcarriers. The modulation symbols on the regularly spaced subcarriers for a respective portion of the preamble (e.g., for each portion except the first portion) are phase-shifted (956) with respect to the modulation symbols on the regularly spaced subcarriers for a previous portion of the preamble (e.g., in accordance with Eq. 1). A transformation from the frequency domain to the time domain (e.g., an IFFT, FIGS. 3-5) is performed (958) to produce a signal that provides a repeating sequence of samples (e.g., the repeating sequence 250(1)-250(M), FIG. 2B) for each portion of the preamble when the subcarriers outside of the subset of contiguous subcarriers are filtered out. A CP is added (960) to each portion of the preamble in the time domain.

The method 950 may further include placing one or more pilot symbols (e.g., pilot symbols 640, FIG. 6) in the preamble.

While the methods 900 and 950 include a number of operations that appear to occur in a specific order, it should be apparent that the methods 900 and 950 can include more or fewer operations, which can be executed serially or in parallel. An order of two or more operations may be changed, performance of two or more operations may overlap, and two or more operations may be combined into a single operation. Furthermore, the methods 900 and 950 may be combined into a single method, such that the preamble is generated in a combination of the operation 906 (e.g., including the operations 908, 910, and 912) and the operation 952 (e.g., including the operations 954, 956, 958, and 960).

In the foregoing specification, the present embodiments have been described with reference to specific exemplary embodiments thereof. It will, however, be evident that various modifications and changes may be made thereto without departing from the broader scope of the disclosure. The specification and drawings are, accordingly, to be regarded in an illustrative sense rather than a restrictive sense.

1. A method of signal generation, comprising:
selecting a subset of contiguous OFDM symbols from a set of contiguous OFDM symbols;
selecting a subset of contiguous subcarriers from a set of subcarriers; and
generating a preamble occupying the subset of contiguous subcarriers in the subset of contiguous OFDM symbols, wherein:
the preamble comprises portions in respective OFDM symbols of the subset of contiguous OFDM symbols,
in the time domain each portion of the preamble corresponds to a repeating sequence of samples when subcarriers outside of the subset of contiguous subcarriers are filtered out, and
the generating comprises flipping the sign of one or more occurrences of the repeating sequence of samples for a final portion of the preamble in one or more final OFDM symbols of the subset of contiguous OFDM symbols.

2. The method of claim 1, wherein generating the preamble further comprises:
in the frequency domain, within each portion of the preamble, activating regularly spaced subcarriers in the subset of contiguous subcarriers and nulling other subcarriers in the subset of contiguous subcarriers;
performing a transformation from the frequency domain to the time domain to produce a signal that provides the repeating sequence of samples for each portion of the preamble when the subcarriers outside of the subset of contiguous subcarriers are filtered out; and
adding a cyclic prefix to each portion of the preamble in the time domain.

3. The method of claim 2, wherein:
activating the regularly spaced subcarriers comprises, for each portion of the preamble, placing modulation symbols on the regularly spaced subcarriers; and
generating the preamble further comprises phase-shifting the modulation symbols on the regularly spaced subcarriers for a respective portion of the preamble with respect to the modulation symbols on the regularly spaced subcarriers for a previous portion of the preamble.

4. The method of claim 3, wherein the modulation symbols comprise quadrature amplitude modulation (QAM) symbols.

5. The method of claim 2, wherein flipping the sign comprises shifting the regularly spaced subcarriers for the final portion of the preamble with respect to the regularly spaced subcarriers of previous portions of the preamble.

6. The method of claim 2, wherein:
the subset of contiguous subcarriers is symmetric about a DC subcarrier; and
the regularly spaced subcarriers are symmetric about the DC subcarrier.

7. The method of claim 2, wherein generating the preamble further comprises nulling subcarriers in a guard band at each end of the subset of contiguous subcarriers.

8. The method of claim 1, further comprising placing one or more pilot symbols in the preamble.

9. A method of signal generation, comprising:
selecting a subset of contiguous OFDM symbols from a set of contiguous OFDM symbols;
selecting a subset of contiguous subcarriers from a set of subcarriers; and
generating a preamble occupying the subset of contiguous subcarriers in the subset of contiguous OFDM symbols, the preamble comprises portions in respective OFDM symbols of the subset of contiguous OFDM symbols, the generating comprising:
in the frequency domain, within each portion of the preamble, placing modulation symbols on regularly spaced subcarriers in the subset of contiguous subcarriers, and
phase-shifting the modulation symbols on the regularly spaced subcarriers for a respective portion of the preamble with respect to the modulation symbols on the regularly spaced subcarriers for a previous portion of the preamble.

10. The method of claim 9, wherein generating the preamble further comprises:
performing a transformation from the frequency domain to the time domain to produce a signal that provides a repeating sequence of samples for each portion of the preamble when subcarriers outside of the subset of contiguous subcarriers are filtered out; and
adding a cyclic prefix to each portion of the preamble in the time domain.

11. The method of claim 10, wherein phase-shifting the modulation symbols comprises shifting a phase of the modulation symbols by an amount 2πfN_{CP}/N_{SC}, where f is a subcarrier index, N_{SC} is a number of available subcarriers, and N_{CP} is a number of samples in the cyclic prefix.

12. The method of claim 10, further comprising flipping the sign of one or more occurrences of the repeating sequence of samples for a final portion of the preamble in one or more final OFDM symbols of the subset of contiguous OFDM symbols.

13. The method of claim 9, wherein generating the preamble further comprises nulling subcarriers other than the regularly spaced subcarriers within each portion of the preamble.

14. The method of claim 13, wherein generating the preamble further comprises nulling subcarriers in a guard band at each end of the subset of contiguous subcarriers.

15. The method of claim 9, wherein the modulation symbols comprise quadrature amplitude modulation (QAM) symbols.

16. The method of claim 9, wherein:
the subset of contiguous subcarriers is symmetric about a DC subcarrier; and
the regularly spaced subcarriers are symmetric about the DC subcarrier.

17. The method of claim 9, further comprising placing one or more pilot symbols in the preamble.

18. A communications device, comprising:
a transmitter to transmit frames on multiple subcarriers, the frames each comprising multiple contiguous OFDM symbols, wherein:
a respective frame comprises a preamble occupying a contiguous subset of the multiple subcarriers and comprising portions in respective OFDM symbols of a contiguous subset of the multiple contiguous OFDM symbols,
in the time domain each portion of the preamble corresponds to a repeating sequence of samples when subcarriers outside of the contiguous subset of the multiple subcarriers are filtered out, and
the sign of one or more occurrences of the repeating sequence of samples is flipped for a final portion of the preamble in one or more final OFDM symbols of the contiguous subset of the multiple contiguous OFDM symbols.

19. The communications device of claim 18, wherein, to generate the preamble, the transmitter is to:
in the frequency domain, within each portion of the preamble, activate regularly spaced subcarriers in the contiguous subset of the multiple subcarriers and null other subcarriers in the contiguous subset of the multiple subcarriers;
perform a transformation from the frequency domain to the time domain to produce a signal that provides the repeating sequence of samples for each portion of the preamble when the subcarriers outside of the contiguous subset of the multiple subcarriers are filtered out; and
add a cyclic prefix to each portion of the preamble in the time domain.

20. The communications device of claim 19, wherein the transmitter is to place modulation symbols on the regularly spaced subcarriers and phase-shift the modulation symbols on the regularly spaced subcarriers for a respective portion of the preamble with respect to the modulation symbols on the regularly spaced subcarriers for a previous portion of the preamble.

21. The communications device of claim 20, wherein the modulation symbols comprise quadrature amplitude modulation (QAM) symbols.

22. The communications device of claim 19, wherein the transmitter is to shift the regularly spaced subcarriers for the final portion of the preamble with respect to the regularly spaced subcarriers of previous portions of the preamble, to flip the sign of the one or more occurrences of the repeating sequence of samples.

23. The communications device of claim 19, wherein:
the contiguous subset of the multiple subcarriers is symmetric about a DC subcarrier; and
the regularly spaced subcarriers are symmetric about the DC subcarrier.

24. The communications device of claim 19, wherein the transmitter is to null subcarriers in a guard band at each end of the contiguous subset of the multiple subcarriers.

25. The communications device of claim 18, wherein the transmitter is to place one or more pilot symbols in the preamble.

26. A receiver, comprising:
a filter to extract samples corresponding to a signal carried on a contiguous group of subcarriers that form a subset of a set of available subcarriers;
a preamble detector to detect a preamble in the extracted samples, the preamble comprising a repeating sequence of samples; and
a preamble boundary searcher to identify an end of the preamble as indicated by one or more occurrences of the repeating sequence of samples having flipped signs with respect to previous occurrences of the repeating sequence of samples.

27. The receiver of claim 26, further comprising a sliding correlator, selectively coupled between the filter and the preamble detector, to calculate values of a correlation function based on the extracted samples;
wherein the preamble detector is to detect the preamble based in part on the values of the correlation function.

28. The receiver of claim 27, wherein the preamble detector is to calculate values of an energy function based on the extracted samples and to detect the preamble based on values of a difference between the correlation function and the energy function.

29. The receiver of claim 27, further comprising a switch to selectively couple the sliding correlator to the preamble detector and the preamble boundary searcher, wherein:
the switch is to couple the sliding correlator to the preamble detector before detection of the preamble by the preamble detector;
the switch is to couple the sliding correlator to the preamble boundary searcher in response to detection of the preamble by the preamble detector; and
the preamble boundary searcher is to identify the end of the preamble based on the values of the correlation function.

30. The receiver of claim 26, further comprising a carrier frequency offset (CFO) estimation module to estimate CFO based on the preamble.

31. The receiver of claim 30, further comprising:
a sample buffer to buffer samples corresponding to a received signal;
a CFO compensation module to compensate for the estimated CFO during a tracking mode; and
a switch to selectively couple the sample buffer to the CFO compensation module and the filter;
wherein the switch is to couple the sample buffer to the filter before identification of the end of the preamble by the preamble boundary searcher; and
wherein the switch is to couple the sample buffer to the CFO compensation module in response to identification of the end of the preamble by the preamble boundary searcher.

32. A receiver, comprising:
means for extracting samples corresponding to a signal carried on a contiguous group of subcarriers that form a subset of a set of available subcarriers;
means for detecting a preamble in the extracted samples, the preamble comprising a repeating sequence of samples; and
means for identifying an end of the preamble as indicated by one or more occurrences of the repeating sequence of samples having flipped signs with respect to previous occurrences of the repeating sequence of samples.

33. The receiver of claim 32, further comprising means for calculating values of an energy function based on the extracted samples; wherein the means for detecting the preamble comprise means for detecting the preamble based in part on the values of the energy function.

34. The receiver of claim 32, further comprising:
means for estimating CFO based on the preamble; and
means for compensating for the estimated CFO during a tracking mode.
